(19) United States
(12) Patent Application Publication
(10) Pub. No.: US 2010/0013998 A1
(43) Pub. Date: Jan. 21, 2010

(54) INTELLIGENT TASK BASED USER INTERFACE FOR TELEVISION

(76) Inventor: Peter Mortensen, Tustin, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/174,797

(22) Filed: Jul. 17, 2008

(51) Int. Cl. H04N 5/46; H04N 5/44

(52) U.S. Cl. 348/558; 348/734; 348/E05.096; 348/E05.114

(57) ABSTRACT

Systems and methods for the implementation of a task or activities based user interface on a television on screen display (OSD) and a remote control unit. As provided in the embodiments described herein, the embodiments utilize the device auto detect mechanisms incorporated in HDMI 1.3 (CEC) and 1394 compliant televisions and other audio-video components to provide a user interface on the OSD or remote control unit providing activities or tasks based control.

### FIELD

The present invention relates generally to televisions and, more particularly, to an intelligent task based user interface for televisions.

### BACKGROUND

The capabilities and features of televisions continue to expand and improve. Many televisions include features and capabilities that allow a user or operator to fine tune picture and audio performance, device setup and the like in order to provide the highest quality presentation for a given viewing environment and content to be viewed. As these capabilities become more affordable, more and more consumers will seek a true theater experience with a complete compliment of audio-video components forming their entertainment system. Such systems, however, tend to be complicated to control and operate.

The consumer electronic control (CEC) standard has been implemented in an effort to simplify the control of the system components. Universal remote control unit manufacturers have attempted to take advantage of the features available with CEC compliant components by developing a task or activity based user interface that enables the user to succeed in proceeding with a task or activity such as, e.g., “watch a DVD”, by pressing a single button on the remote, which causes the DVD, television and audio-video receiver to turn-on, perform necessary input switching, and play the DVD program video on the television screen and output the sound over the system's loud speakers. Such remote control units must be synched to a computer and then programmed for the first time to control each component in the entertainment system. However, each time a new component is added to the system, the remote control unit must be again synched to a computer and then programmed to control the new device. This process is not only inconvenient to the user, but it is often fraught with problems.

### SUMMARY

Embodiments described herein are directed to improved systems and methods that facilitate the implementation of an activities or tasks based user interface displayable on a display screen of a television and/or remote control unit. As provided in the embodiments described herein, the embodiments utilize the device auto detect mechanisms incorporated in HDMI 1.3 (CEC) and 1394 compliant televisions and other audio-video components to provide a user interface within the OSD of the television and/or the remote control unit providing activities or task-based control. For example, when the user connects, e.g., a DVD player with HDMI CEC support, the television will automatically detect the device as a DVD player and provide a direct feature in the user interface called “Watch DVD” or “Play DVD”. No other manual configuration is necessary.

A two-way RF interface such as, e.g., Zigbee or Z-Wave, can be used to transmit the same user interface functionality from the television to the remote.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television system.

FIG. 2 is a top view of a remote control unit.

FIG. 3 is a schematic of the operating system of the remote control unit.

FIG. 4 is a flow chart schematic showing system operation.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Embodiments described herein are directed to improved methods and systems for the implementation of a task or activities based user interface displayable within an on screen display (OSD) of a television and/or a remote control unit. As provided in the embodiments described herein, the embodiments utilize the device auto detect mechanisms incorporated in HDMI 1.3 (CEC) and 1394 compliant televisions and other audio-video components to provide a user interface displayable within the OSD of the television and/or the remote control unit providing activities or tasks based control. For example, when the user connects, e.g., a DVD player with HDMI CEC support, the television will automatically detect the device as a DVD player and provide a direct feature in the user interface called “Watch DVD” or “Play DVD”. No other manual configuration is necessary. A two-way RF interface such as, e.g., Zigbee or Z-Wave, can be used to transmit the same user interface functionality from the television to the remote.

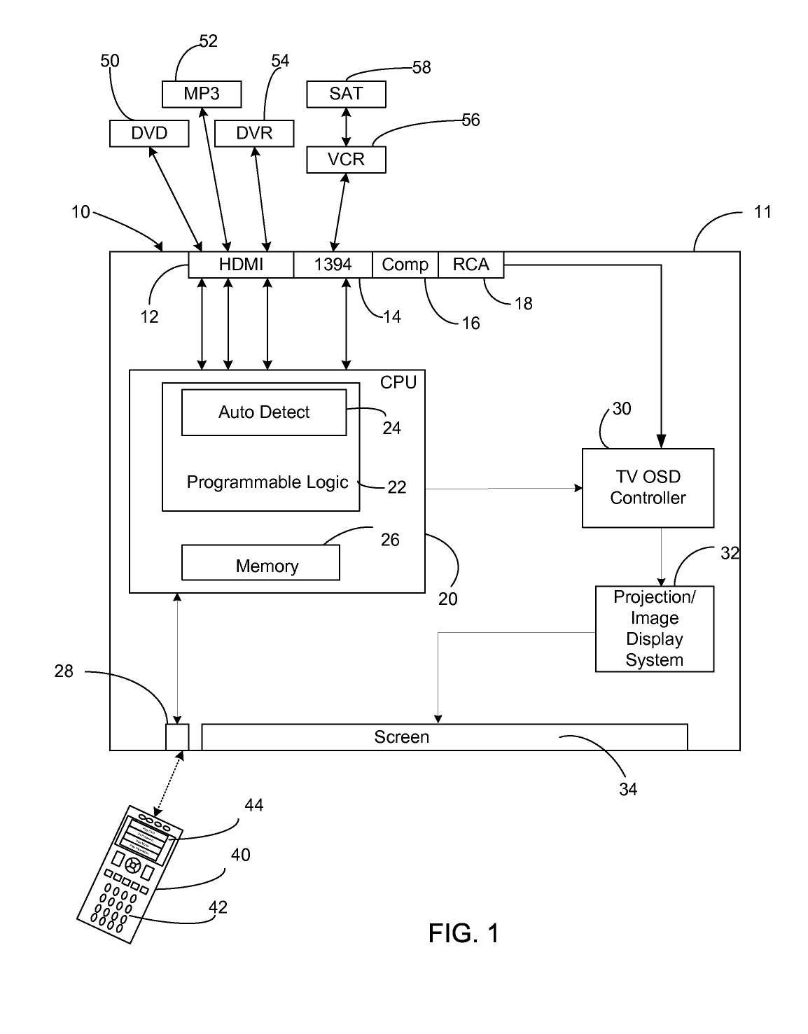

Turning to the figures, the embodiments provided herein are described in detail. A typical television 10, as depicted in FIG. 1, includes an enclosure 11 and a screen 34 housed in or coupled to the enclosure 11. Housed within the enclosure 11 is a central processing unit (CPU) 20 including non-volatile memory 26 and programmable logic 24, which can be in the form of system software stored in memory, integrated circuits, application specific integrated circuit chips and the like. The software preferably comprises a set of instructions to enable the setup and operation of the television system 10. The programmable logic 22 preferably includes an auto detect module 24.

Also housed within the enclosure 11 is an image display system 32, such as a projection system or the like, coupled to the screen 34, and an on screen display (OSD) controller 30 coupled to the CPU 20 and the image display system 32. The OSD 30 controls what is displayed on the screen 34.

The television system 10 preferably further includes a remote control device 40 wirelessly coupled to the television 10 to operate and control the television. As discussed in greater detail below, the remote control device 40 includes a display screen 44 and a function keypad 42. The remote control device 40 can send infra red (IR) signals, radio frequency (RF) signals or the like that are received by a receiver 28 housed in the enclosure 11 of the television 10 and coupled to the CPU 20. The remote control device 40 preferably sends and receives radio frequency (RF) signals to and from the television system 10 in which the receiver 28 is an RF transmitter-receiver. The televisions system 10 can also be controlled through the use of buttons positioned on a control panel (not shown) located on the enclosure 11 and coupled to the CPU 20.

The television system 10 also preferably includes multiple input ports including HDMI ports 12, 1394 ports 14, component ports 16 and RCA ports 18 coupled to OSD controller 30. The HDMI ports 12 and 1394 ports 14 are preferably coupled to the CPU 20 over a bidirectional bus to allow the control commands form HDMI(CEC) and 1394 to flow to and from the connected devices. As depicted, HDMI compliant components such as, e.g., a DVD 50, an MP3 52 and a DVR 54, and 1394 compliant components such as, e.g., a SAT 58 and a VCR 56, are coupled to the HDMI ports 12 and 1394 ports 14 over bi-directional cables.

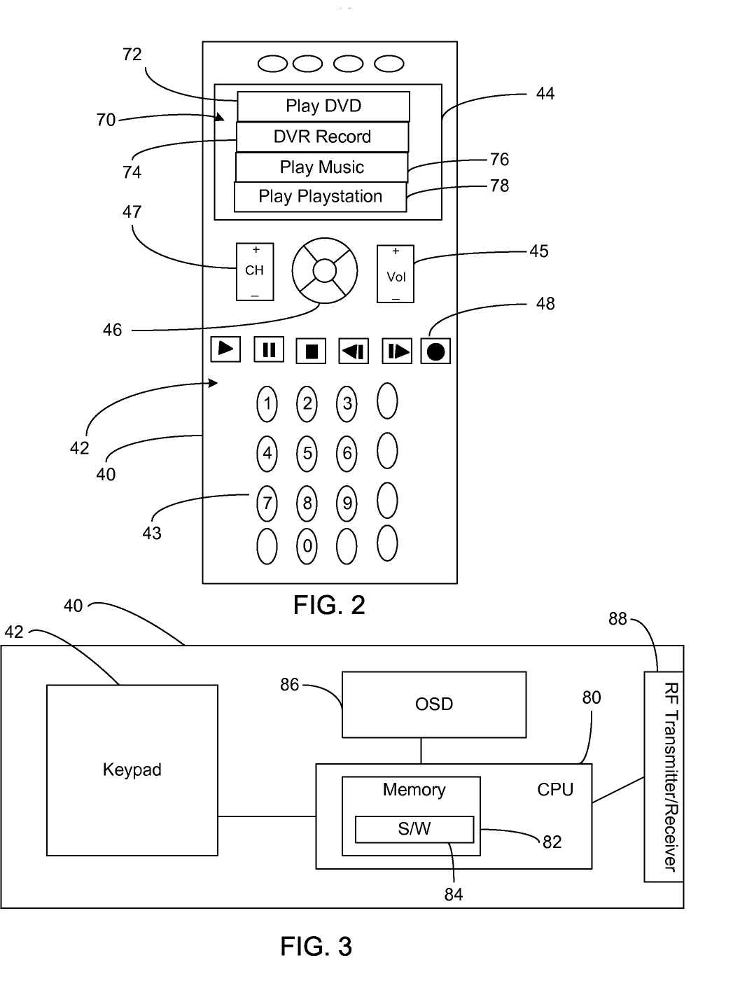

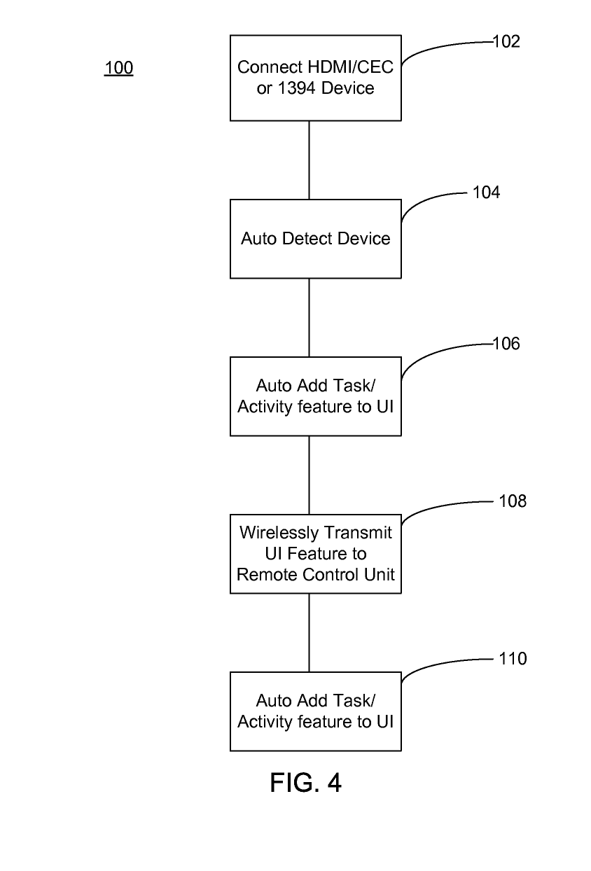

Turning to FIGS. 2 and 3, the remote control device 40 includes a CPU 80 including non-volatile memory 82 and programmable logic 84, which can be in the form of system software stored in memory, integrated circuits, application specific integrated circuit chips and the like. The software preferably comprises a set of instructions to enable the setup and operation of the remote control device 40. Coupled to the CPU 80 is an RF transmitter/receiver 88, an display controller 86, which is coupled to the display screen 44, and the function keypad 42. As shown in FIG. 2, the function keypad 42 includes a numeric keypad 43, a record and playback keypad 48, a cursor/select key 46, a channel up/down key 47, a volume up/down key 45, and the like.

As shown in FIG. 2, a task/activities based user interface 70 is displayed on the display screen 44. The user interface 70, which includes activities such as, e.g., Play DVD 72, DVR Record 74, Play Music 76, Play Playstation 78 and the like, is navigatable using the cursor/select key 46 and the volume up/down and channel up/down keys 47 and 45. Alternatively, the display screen 44 can be a touch screen.

The setup process 100, as depicted in FIG. 3, includes connecting 102 an HDMI/CEC or 1394 compliant audio-video input device to the appropriate port on the television system 1O. Once connected, the device is auto-detected 104 by the television system 10 and prompted to transmit its control features to the television system 10. The television system 10 auto adds 106 the task/activities based features to its on screen display user interface and transmits 108 the task/activities based features to the remote control device 40 which adds 110 these same features to its on screen display user interface 70.

In operation, a task or activity such as “Play DVD” can be accomplished by making the selection of the task or activity from the user interface on the display of the television or remote. Once the selection is made, the DVD, television and audio-video receiver are caused to turn-on if not already on and perform the necessary input switching to play the DVD program video on the television screen and output the audio over the system's loud speakers.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A television system comprising comprising
a television having a control system adapted to detect an HDMI/CEC or 1394 compliant audio-video (A-V) device connected to the television and prompt the A-V device to transmit its task-based control features to the television, and
a remote control unit bi-directionally wirelessly coupled to the television and having a display screen and a control system coupled to the display screen, where the television control system is configured to cause the task-based control features received from an A-V device coupled to the television to be transmitted to the remote control unit, and wherein the remote control unit control system is configured to add the task-based control features from the A-V devise the user interface displayed on the display screen of the remote control unit.

2. The television system of claim 1 wherein the control system of the television comprises a central processing unit, an image display system couple to a screen, and an onscreen display controller.

3. The television system of claim 2 where in the central processing unit includes non-volatile memory.

4. The television system of claim 3 where in the control system further comprises system software stored in the non-volatile memory and executable on the central processing unit, wherein the system software includes a set of instructions.

5. The television system of claim 2 where in the television further comprises a bi-directional transmitter-receiver coupled to the control system.

6. The television system of claim 5 where in the remote control unit comprises a bi-directional transmitter-receiver coupled to the control system and wirelessly coupled to the bi-direction transmitter-receiver in the television.

7. The television system of claim 6 where in the control system of the remote control unit comprises a central processing unit and a display controller coupled to the central processing unit.

8. The television system of claim 7 where in the central processing unit includes non-volatile memory.

9. The television system of claim 8 where in the control system further comprises system software stored in the non-volatile memory and executable on the central processing unit, wherein the system software includes a set of instructions.

10. A method of implementing task based control in a television system comprising a television, a remote control bi-directionally wirelessly coupled to the television, and one or more HDMI/CEC or 1394 compliant audio-video input devices coupled to the television, comprising the steps of
detecting the one or more HDMI/CEC or 1394 compliant audio-video input devices coupled to the television,
prompting the one or more HDMI/CEC or 1394 compliant audio-video input devices to transmit its task based control features to the television,
transmitting the task based control features of the one or more HDMI/CEC or 1394 compliant audio-video input devices to the remote control device,
incorporating the task based control features of the one or more HDMI/CEC or 1394 compliant audio-video input devices into the user interface displayable on a screen of the remote control device, and
displaying the user interface with the incorporated task based control features of the one or more HDMI/CEC or 1394 compliant audio-video input devices on the screen of the remote control unit.

11. The method of claim 10 further comprising the step of transmitting a task based activity selected by a user and corresponding to the task based control feature of one of the one or more HDMI/CEC or 1394 compliant audio-video input devices to the television.

12. The method of claim 11 further comprising the step of implementing the task based activity.
